(19) United States
(12) Patent Application Publication
(10) Pub. No.: US 2026/0366913 A1
(43) Pub. Date: Nov. 19, 2026

(54) Electrical Substitution Radiometric Source Device

(71) Applicant: Matter Intelligence Inc., El Segundo, CA (US)

(72) Inventor: Thomas George Chrien, Rancho Palos Verdes, CA (US)

(21) Appl. No.: 19/675,278

(22) Filed: May 12, 2026

Related U.S. Application Data
(60) Provisional application No. 63/805,832, filed on May 14, 2025.

(51) Int. Cl. G01J 1/08; G01J 1/10

(52) U.S. Cl. CPC G01J 1/08; G01J 1/10

(57) ABSTRACT

Embodiments are directed to an electrical substitution radiometric (ESR) source device that can accurately measure an optical power of light output by the ESR source device. The ESR source device includes a light source, a heater in thermal contact with the light source, a temperature sensor in thermal contact with the light source, a heater power apparatus for measuring a first electrical power provided to the heater when the light source is turned off and a second electrical power provided to the heater when the light source is turned on, a light source power apparatus for measuring an electrical power provided to the light source, and a controller controlling power provided to the heater and the light source to maintain a temperature inside an enclosure of the ESR source device at a set point above an ambient temperature when the light source is turned off and turned on.

### CROSS REFERENCE TO RELATED APPLICATIONS

This application claims priority to U.S. Patent Application No. 63/805,832, filed May 14, 2025, which is incorporated by reference herein in its entirety.

### BACKGROUND

Optical sources are typically calibrated using the electrical substitution method. These are typically electrical substitution radiometers (ESRs), which are used to measure optical power by converting light energy into heat. ESRs are used to calibrate various light sources with high precision, such as blackbody radiators, lasers, and light-emitting diodes (LEDs). ESRs are also employed in absolute radiometry to measure light across a wide spectrum, including visible, infrared, and ultraviolet. ESRs can measure optical power over a wide spectral range, depending on the used absorptive material.

The electrical substitution method involves equating the absorbed optical power with an equivalent amount of electrical power to determine the optical source's radiative output. The optical power (i.e., light) is absorbed by a highly absorptive material, often a thermally isolated black coating or cavity. The absorbed light heats the material, causing a temperature increase. A precise electrical current is then applied to a heater placed on the same material to replicate the temperature increase caused by the absorbed light. The electrical power required to match the temperature increase is then measured. Since the electrical power (i.e., P=I*V) can be accurately determined based on the applied electrical current and voltage, the optical power can be inferred from this equivalence.

However, the electrical substitution method and ESRs require the usage of highly absorptive material. Because of that, the cost of implementing ESRs and performing the electrical substitution method can be high. Additionally, this approach for calibrating optical sources is not portable since it cannot be implemented on a side of the optical source.

### SUMMARY

Embodiments of the present disclosure are directed to an electrical substitution radiometric (ESR) source device that can accurately measure an optical power of light output by the ESR source device. In accordance with one or more aspects of the present disclosure, the ESR source device includes a light source configured to emit light, an aperture or a fiber optic for controlling spatial distribution of light output from the ESR source device representing a portion of the light emitted by the light source, an enclosure configured to absorb as heat another portion of the light emitted by the light source that was not output from the ESR source device, a heater in thermal contact with the light source, a temperature sensor in thermal contact with the light source and the enclosure, a heater power supply configured to provide an electrical power to the heater, a first apparatus configured to measure a first electrical power provided to the heater when the light source is turned off and a second electrical power provided to the heater when the light source is turned on, a light source power supply configured to provide an electrical power to the light source, a second apparatus configured to measure the electrical power provided to the light source, and a controller coupled to the temperature sensor, the heater power supply, and the light source power supply. The controller is configured to maintain a temperature inside the enclosure at a set point above an ambient temperature when the light source is turned off and when the light source is turned on.

Embodiments of the present disclosure are further directed to a method performed at the ESR source device for determining the optical power of light output by the ESR source device. The method performed at the ESR source device includes: turning off a light source of the ESR source device; providing a first power to a heater of the ESR source device when the light source is turned off to maintain a temperature inside an enclosure of the ESR source device at a set point temperature; measuring the first power provided to the heater when the light source is turned off; turning on the light source; providing a second power to the heater when the light source is turned on to maintain the temperature inside the enclosure at the set point temperature; measuring the second power provided to the heater when the light source is turned on; determining a heater power consumption drop by subtracting the second power from the first power; providing a third power to the light source while the temperature inside the enclosure is maintained at the set point temperature; measuring the third power provided to the light source; and determining an optical power of light output by the ESR source device by subtracting the heater power consumption drop from the third power.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures (FIGS.) is below.

FIG. 1 illustrates an example electrical substitution radiometric (ESR) source device, in accordance with one or more embodiments.

FIG. 2 illustrates an example ESR source device with a fiber optic, in accordance with one or more embodiments.

FIG. 3 is a flowchart for a method of operating an ESR source device, in accordance with one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Embodiments of the present disclosure are directed to an electrical substitution radiometric (ESR) source device that can accurately measure an optical power of light output by the ESR source device, e.g., that can achieve precise calibration of a light source that is part of the ESR source device. The ESR source device presented herein can be further used to measure a quantum efficiency of a light detector. Furthermore, the ESR source device presented herein can be utilized for creating a spectral radiance source.

In one or more embodiments, an assembly of the ESR source device that includes a temperature-controlled calorimeter with a mounted light source measures power required to keep temperature of the calorimeter at some set point temperature with the light source turned off. The assembly of the ESR source device may then measure a change in temperature control power as the light source is turned on. After that, the assembly of the ESR source device may determine when the temperature of the calorimeter hits steady state. A difference in power applied to the ESR source device needed to keep the temperature of the calorimeter steady when the light source is turned off and the light source is turned off may be used to compute heat emitted by light from the light source that is absorbed within the ESR source device.

An output flux of the ESR source device may be determined using an electrical substitution method. The output light beam may be determined by a precision aperture of the ESR source device. A spectral color of the ESR source device may be determined by a type of light source (e.g., light emitting diode (LED), laser diode, blackbody radiator, etc.) of the ESR source device that is held at a constant temperature. The spectral color of the ESR source device may be measured with a spectrometer. Additionally, the ESR source device may feature a low implementation cost.

When operating a light source (e.g., LED-based light source, laser diode, etc.), only a fraction of input electrical power is transformed into an output optical power, while the remainder goes into heat. For example, for a LED that emits blue light having a wavelength of 450 nanometers (nm), with the operating current of 150 milliamps (mA) and the forward voltage at the operating current of 6.3 volts (V), the electrical input power is equal to 0.945 watts (W). On the other hand, the optical output power at the operating current of 150 mA is 0.25 W, which is 26.4% of the electrical input power, i.e., the LED efficiency is 26.4%. Hence, as there is a substantial difference between the known electrical input power and an optical power output by a light source (e.g., LED), it is desirable to have means for precise calibration of the optical light source, i.e., precise measuring of the optical output power.

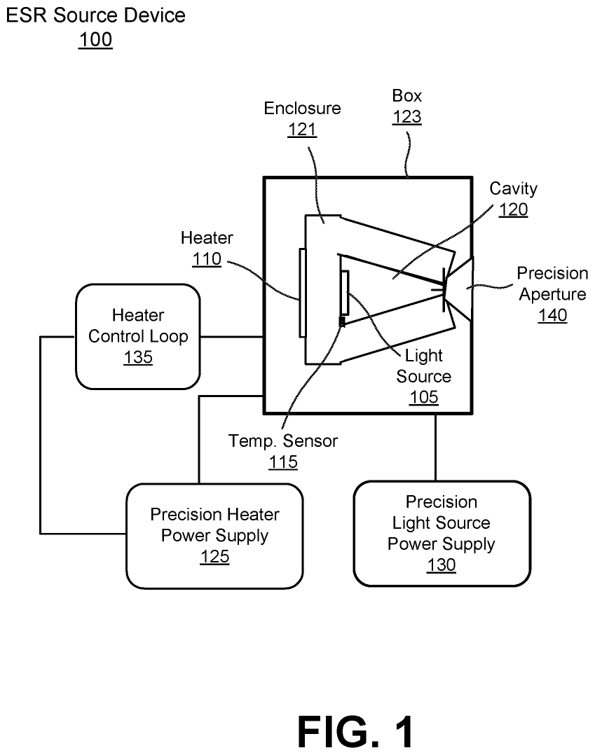

Figure (FIG.) 1 illustrates an example ESR source device 100, in accordance with one or more embodiments. As shown in FIG. 1, ESR source device 100 may include a light source 105 (e.g., LED, laser diode, blackbody radiator, etc.), a heater 110 (e.g., a second light source), and a temperature sensor 115 placed at least partially within a cavity 120 (e.g., high conductance cavity). The temperature sensor 115 may be in thermal contact with the light source 105 and the cavity 120. The ESR source device 100 can operate as a temperature-controlled calorimeter with the light source 105 that is mounted within the cavity 120. Additionally, the ESR source device 100 may include a precision heater power supply 125, a precision light source power supply 130, and a heater control loop 135. The precision heater power supply 125 may be configured to provide precisely controlled electrical power to the heater 110. The precision light source power supply 130 may be configured to provide precisely controlled electrical power to the light source 105. The heater control loop 135 may maintain a temperature inside the cavity 120 at a defined set point above an ambient temperature by controlling the power provided to the heater 110 by the precision heater power supply 125.

An interior of the cavity 120 may have a high emissivity coating, i.e., a coating placed on an inner surface of the cavity 120 may have an emissivity greater than a threshold value. In one or more embodiments, an insulation layer is placed around the cavity 120, e.g., the insulation layer may be along an outer surface of an enclosure 121 surrounding the cavity 120. To suppress the airflow, the enclosure 121 with the cavity 120 may be placed within a box 123. The ESR source device 100 may further feature a precision aperture 140, i.e., an opening at a side surface of the cavity 120. The precision aperture 140 may enable control of a cone of light that exits the cavity 120. The cavity 120 along with the precision aperture 140 may control the area and solid angle of the light that leaves the cavity 120. The light source 105 may be configured such that light emitted by the light source 105 is limited to some area-solid angle product, whereas some light may be re-absorbed as heat within the cavity 120. In one or more embodiments, the precision aperture 140 is replaced with a fiber optic. The ESR source device 100 may include one or more additional components not shown in FIG. 1.

The heater 110 with the heater control loop 135 based on temperature readings from the temperature sensor 115 may heat the cavity 120 to some constant temperature above an ambient temperature. The heater 110 may be driven by the heater control loop 135 to heat (or cool) the cavity 120, e.g., approximately 10 °C above or below ambient. In one or more embodiments, the heater 110 includes a heater drive circuit configured to modulate the temperature of the cavity 120 by a defined temperature level (e.g., 1 °C) at some dither frequency. In such cases, the temperature set point may oscillate sinusoidally. In one or more other embodiments, the heater 110 is replaced with a thermal electric cooler for cooling the cavity 120 to a defined temperature when the light source 105 is turned on. In such cases, the power increase provided to the thermal electric cooler required to cool the cavity 120 when the light source 105 is turned on may be measured.

To determine power used by the heater 110, the precision heater power supply 125 may measure an electrical current and voltage sent to the heater 110. When the light source 105 is turned on, the light source 105 generates heat and light. The precision light source power supply 130 may measure an electrical current and voltage sent to the light source 105 to determine a total electrical power consumed by the light source 105.

Power consumption of the heater 110 may drop due to heat produced by thermal activity of the light source 105 (i.e., heat generated by the light source 105) and light re-absorption as a portion of light emitted by the light source 105 does not escape the cavity 120, i.e., the portion of light emitted by the light source 105 does not exit the ESR source device 100 through the precision aperture 140. An optical output power of the ESR source device 100 (i.e., power of light that exits the ESR source device 100 through the precision aperture 140) may be determined by subtracting a change in electrical power (due to turning the light source 105 on and off) provided to the heater 110 by the precision heater power supply 125 from the electrical input power provided to the light source 105 by the precision light source power supply 130.

With the light source 105 and the heater 110 are turned on, the power provided to the light source 105 and to the heater 110 may be measured by measuring the voltage and current applied to the light source 105 and the heater 110. In addition, the temperature inside the cavity 120 may be measured by the temperature sensor 115 and is a function of time. A curve fit over multiple cycles may be used to determine a change of temperature over time, ΔT, i.e., Fit Pₕ(t)=a+bΔT+c dT/dt over multiple cycles, where Pₕ(t) is the power provided to the heater 110 over time, and a, b, c are fitting parameters.

To calibrate the ESR source device 100, the power provided to the light source 105 may be set to zero, i.e., the light source 105 may be turned off. Then, the change in power required to dither a temperature within the cavity 120 may be measured. The measured power may be equal to the heat that was supplied by the light source 105. Since the total power to the light source 105 may be electrically measured, a portion of this power that goes into heating the cavity 120 can be subtracted. The remainder is the power that is emitted as light outside of the cavity 120 through the precision aperture 140. The light output power may be further characterized by measuring the area-solid angle product emitted by the cavity 120, which does not change over time.

In one or more embodiments, a monochromator/spectrometer can be used to measure spectral distribution (e.g., spectral content) of light output outside of the cavity 120 through the precision aperture 140. The optical output power may be distributed over the measured spectrum. On and off cycles of the light source 105 may enable continuous baseline of electrical substitution power. The ESR source device 100 may utilize the light source 105 of various colors as a light source. For the light source 105 that is a LED lamp, holding the light source 105 at a constant temperature may facilitate keeping the output light spectrally repeatable.

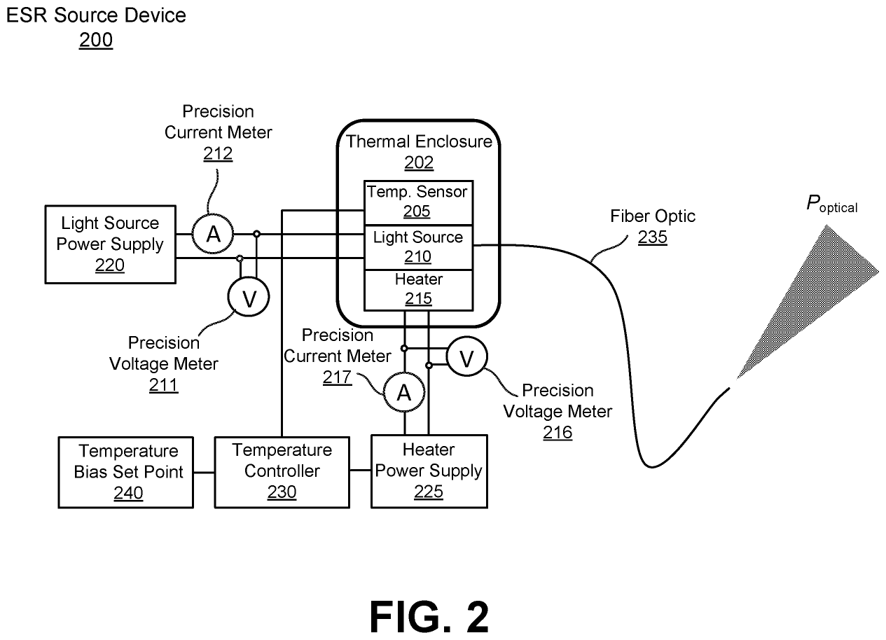

FIG. 2 illustrates an example ESR source device 200 with a fiber optic, in accordance with one or more embodiments. The ESR source device 200 may include a temperature sensor 205, a light source 210 (e.g., LED, laser diode, etc.), and a heater 215 (e.g., second LED or some other light source) placed inside a thermal enclosure 202 (or within a cavity defined by the thermal enclosure 202). Outside of the thermal enclosure 202, the ESR source device 200 may further include a light source power supply 220 for providing electrical input power to the light source 210, means for measuring power of the light source 210 (i.e., electrical current and voltage provided to the light source 210), a heater power supply 225 for providing electrical input power to the heater 215, means for measuring power of the heater 215 (i.e., electrical current and voltage provided to the heater 215), a temperature controller 230 coupled to the temperature sensor 205 and the heater power supply 225, and a fiber optic 235 for conducting light emitted by the light source 210 outside of the thermal enclosure 202. The ESR source device 200 may include one or more additional components not shown in FIG. 2. For example, in one or more embodiments, instead of the fiber optic 235, the thermal enclosure 202 features an aperture through which a portion of light emitted from the light source 210 exits the thermal enclosure 202 and the ESR source device 200.

The thermal enclosure 202 may serve as a heat sink. In addition to the light source 210 mounted to the thermal enclosure 202, the thermal enclosure 202 includes the heater 215 and a temperature sensor 205 (e.g., thermal couple) thermally attached to the thermal enclosure 202 and the light source 210. The ESR source device 200 may also include electrical connection (e.g., wires) to power the light source 210 by the light source power supply 220, to power the heater 215 by the heater power supply 225, and to read the temperature sensor 205. In one or more embodiments, the heater 215 is also configured to operate as a cooler able to decrease a temperature inside the thermal enclosure 202.

The thermal enclosure 202 may feature one or more heat loss paths, including conductive losses through the electrical wires and mounting. There may be also convective and/or radiative loss mechanisms, but these can be minimized or at least reduced by wrapping the thermal enclosure 202 in an insulation and placing the thermal enclosure 202 in a box to suppress airflow. The goal is that the heat loss path is limited to a fixed value that does not change as the light source 210 is powered on or off by the light source power supply 220.

The temperature controller 230 may receive a first temperature signal from the temperature sensor 205 indicative of a temperature inside the thermal enclosure 202 when the light source 210 is turned off. The temperature controller 230 may control the heater power supply 225 using the first temperature signal to maintain the temperature inside the thermal enclosure 202 to the temperature bias set point 240 when the light source 210 is turned off.

The temperature controller 230 may receive a second temperature signal from the temperature sensor 205 indicative of a temperature inside the thermal enclosure 202 when the light source 210 is turned on. The temperature controller 230 may control the heater power supply 225 using the second temperature signal to maintain the temperature inside the thermal enclosure 202 to the temperature bias set point 240 when the light source 210 is turned on. Additionally, the temperature controller 230 may control the light source power supply 220 using the second temperature signal to maintain the temperature inside the thermal enclosure 202 to the temperature bias set point 240 when the light source 210 is turned on.

The means for measuring power of the light source 210 may include a precision voltage meter 211 and a precision current meter 212. The means for measuring power of the light source 210 may measure power of the light source 210 by measuring the electrical current (e.g., by the precision current meter 212) and voltage (e.g., by the precision voltage meter 211) provided to the light source 210 by the light source power supply 220. Thus, power of the light source, P_{LS}, may be measured as I_{LS}*V_{LS}, where I_{LS} is the electrical current provided to the light source 210 and measured by the precision current meter 212, and V_{LS} is the voltage applied to the light source 210 and measured by the precision voltage meter 211.

The means for measuring power of the heater 215 may include a precision voltage meter 216 and a precision current meter 217. The means for measuring power of the heater 215 may measure power of the heater 215 by measuring the electrical current (e.g., by the precision current meter 217) and voltage (e.g., by the precision voltage meter 216) provided to the heater 215 by the heater power supply 225. Thus, power of the heater 215, Pₕₑₐₜₑᵣ, may be measured as Iₕₑₐₜₑᵣ*Vₕₑₐₜₑᵣ, where Iₕₑₐₜₑᵣ is the electrical current provided to the heater 215 and measured by the precision current meter 217, and Vₕₑₐₜₑᵣ is the voltage applied to the heater 215 and measured by the precision voltage meter 216.

The temperature controller 230 may control power sent to the heater 215 by controlling the heater power supply 225 such that to maintain a temperature bias set point 240 above an ambient temperature. When the light source 210 is turned off, the entire power of the heater 215 provided by the heater power supply 225 is turned into heat that is lost to an ambient. Thus, when the light source 210 is turned off the following holds:

P_{heat loss}=Pₕₑₐₜₑᵣ (LS off)(bias set point temp.), (1)

where P_{heat loss} is the power (i.e., heat) lost to the ambient, and Pₕₑₐₜₑᵣ (LS off) (bias set point temp.) is the power provided to the heater 215 by the heater power supply 225 when the light source 210 is turned off to maintain the temperature bias set point 240. The means for measuring power of the heater 215 may measure Pₕₑₐₜₑᵣ (LS off) (bias set point temp.) by measuring the electrical current provided to the heater 215, Iₕₑₐₜₑᵣ, and the voltage applied to the heater 215, Vₕₑₐₜₑᵣ, when the light source 210 is turned off.

When the light source 210 is turned on, to maintain the temperature bias set point 240, power provided to the heater 215 can drop due to heat produced by the light source 210 and a portion of light generated by the light source 210 that is absorbed by the thermal enclosure 202 as the portion of light generated by the light source 210 that does not enter the fiber optic 235 is absorbed as heat. Hence, when the light source 210 is turned on, a smaller amount of power is provided to the heater 215 by the heater power supply 225 (as controlled by the temperature controller 230) to maintain the temperature bias set point 240. By measuring the electrical current provided to the heater 215, Iₕₑₐₜₑᵣ, and the voltage applied to the heater 215, Vₕₑₐₜₑᵣ, when the light source 210 is turned on, the means for measuring power of the heater 215 may measure Pₕₑₐₜₑᵣ (LS on), i.e., the electrical power provided to the heater 215 when the light source 210 is turned on that is required to maintain the temperature bias set point 240. Hence, a decrease in power provided to the heater 215 by the heater power supply 225 when the light source 210 is turned on compared to power provided to the heater 215 by the heater power supply 225 when the light source 210 is turned off is:

Pₕₑₐₜₑᵣ(LS off)−Pₕₑₐₜₑᵣ(LS on). (2)

The decrease in power provided to the heater 215 is related to a portion of light emitted by the light source 210 that is transferred into heat due to operation of the light source 210 and absorption by the thermal enclosure 202. Thus, the optical output power, P_{optical}, may be then measured by subtracting the decrease in power provided to the heater 215 as defined by Eq. (2) from power provided to the light source 210, P_{LS}, i.e.,

P_{optical}=P_{LS}−{Pₕₑₐₜₑᵣ(LS off)−Pₕₑₐₜₑᵣ(LS on)}. (3)

In one or more other embodiments, the heater 215 is replaced with a thermal electric cooler for cooling an inside of the thermal enclosure 202 to the temperature bias set point 240 when the light source 210 is turned on. Alternatively, the heater 215 may be configured to have a dual function, i.e., to operate as a heater or cooler. Alternatively, in addition to the heater 215, a thermal electric cooler may be placed inside the thermal enclosure 202. Power provided to the thermal electric cooler that is required to cool the inside of the thermal enclosure 202 to the temperature bias set point 240 when the light source 210 is turned on may be measured by the precision voltage meter 216 and the precision current meter 217. In such cases, the measured power P_{cooler} (LS on) would replace Pₕₑₐₜₑᵣ (LS on) in Eq. (2) and Eq. (3).

The spectral color of light emitted by the light source 210 may depend on a type of the light source 210 and the temperature bias set point 240 at which the light source 210 is held. Hence, a range of wavelengths (i.e., range of colors) can be supported by the ESR source device 200. In one or more embodiments, the light source 210 is a LED, laser diode, or some other type of light source. A wavelength of light emitted by the ESR source device 200 that includes a laser diode as the light source 210 can be tuned by maintaining a specific temperature bias set point. For example, when the temperature controller 230 changes the temperature bias set point 240, a range of wavelengths between 760 nm and 2350 nm can be produced by the ESR source device 200 that includes the laser diode as the light source 210. In one or more embodiments, when the light source 210 is a LED whose wavelength is a mild function of temperature, light that is output by the ESR source device 200 may have a consistent spectrum if the LED is maintained at the same temperature bias set point 240.

In one or more embodiments, the light source 210 is a LED laser light source that uses, e.g., 5V power source of the light source power supply connected across the wires and starts to emit 650 nm light at approximately 5 mW optical power level. The exact power level can be determined using the electrical substitution method. The heater 215 and the temperature sensor 205 are attached to the LED laser light source. A thermal control loop as shown in FIG. 2 can be used to control the LED laser light source to, e.g., approximately 30 °C. The power supplied to the heater 215 may be measured by the precision voltage meter 216 and the precision current meter 217 to keep the thermal enclosure at 30 °C with the LED laser light source turned off. It is important that the precision voltage meter 216 and the precision current meter 217 accurately measure the voltage and current provided to the heater to accurately perform the power measurement of the heater 215.

While LED lasers are prone to changing wavelength with temperature, this can be avoided by controlling the temperature of the thermal enclosure 202 to a fixed temperature (e.g., 30 °C). The spectral power distribution of the LED laser light source may be measured using a monochromator/spectrometer. Additionally, the monochromator/spectrometer may also measure a spectrum of any other output light emitted away from the 650 nm nominal wavelength. Furthermore, the area sold-angle product of the laser beam output outside of the thermal enclosure 202 may be characterized using a camera (e.g., CMOS camera) at various distances from the beam (e.g., to measure beam profile). The power of the LED laser light source may be determined by measuring the voltage and current supplied to the LED laser light source using the precision voltage meter 211 and the precision current meter 212. The accuracy of measuring the power supplied to the LED laser light source may be also estimated.

The system is operated with the power of the LED laser light source turned on and off. It is possible to measure a rate at which the light source power supply 220 is required to turn the LED laser light source on and off by observing the time constant required to achieve steady state power of the heater 215 and the LED laser light source. The power loss of the thermal enclosure 202 (e.g., calorimeter) may be adjusted by changing the insulation level and/or conductive losses of the thermal enclosure 202. The time constant required to reach the steady state power may depend on the thermal capacitance of the thermal enclosure 202 and the heat loss paths within the thermal enclosure 202. The thermal capacitance of the thermal enclosure 202 and the heat loss paths within the thermal enclosure 202 may be adjusted to suit measurement needs.

In one or more embodiments, a method can be applied where the power on and off provided to the LED laser light source by the light source power supply 220 is dithered to evaluate whether it is possible to avoid the heat measurement over a long time constant. The optical output power, P_{optical}, may be determined as the total power input to the LED laser light source decreased by the change in power provided to the heater 215 required to keep the thermal enclosure 202 at 30 °C when the LED laser light source it turned on, i.e.,

P_{optical}=laser electrical power in−change in heater electrical power. (4)

An error budget may be constructed to estimate accuracy of the optical power prediction. Components of the error budget may include: (1) accuracy of the supplied laser power which may depend on accuracies of voltage and current measurements performed by the precision voltage meter 211 and the precision current meter 212; (2) accuracy of the heater power change which may depend on accuracies of voltage and current measurements performed by the precision voltage meter 216 and the precision current meter 217; (3) accuracy of the light beam spectral measurements; (4) accuracy of the light beam spatial measures; (5) one or more other factors.

In one or more other embodiments, the light source 210 is a LED. In such cases, operations and measurements are substantively same as operations and measurements conducted for the light source 210 that is a LED laser light source. One difference may be the need for utilizing the fiber optic 235 to control area-solid angle product of output light beam. The LED that is used as the light source 210 can be an ultraviolet (UV) LED, LED emitting light in a visible spectrum, near-infrared (NIR) LED, mid-wave infrared (MWIR) LED, or some other type of LED.

In one or more other embodiments, the light source 210 is a halogen lamp source. In such cases, operations and measurements are substantively same as operations and measurements conducted for the light source 210 implemented as a LED laser light source. One difference may be the usage of much higher power levels (e.g., 200 W or higher). The thermal enclosure 202 (e.g., source cavity) may be larger in volume to handle the heat load. A color temperature of the halogen lamp source can be highly controlled to keep spectral output distribution constant.

In one or more embodiments, the ESR source device presented herein includes the following components: (1) a light emitting radiometric source (e.g., LED, laser diode, or some other light source); (2) a precision aperture or fiber optic with well characterized aperture and numerical aperture for controlling (i.e., means for controlling) a spatial distribution of light output from the ESR source device using; (3) means to ensure that light not passing through the precision aperture or fiber optic is absorbed as heat within an assembly of the ESR source device; (4) a heater in close thermal contact with the light source; (5) a temperature sensor in close thermal contact with the light source and an interior of the assembly; (6) a control loop to maintain a temperature of the ESR source device at a defined set point, T_setpoint, above the ambient temperature; (7) a precision voltage and current supply to the light source; (8) precision voltage and current supply to the heater; (9) a thermal enclosure which rapidly dissipates heat from the ESR source device; (10) means to measure electrical power (e.g., voltage and current) supplied to the heater, such as a precision voltage meter and precision current meter, where Voltage*Current=Power; (11) means to measure electrical power (e.g., voltage and current) supplied to the light source, such as a precision voltage meter and precision current meter, where Voltage*Current =Power; (12) means to measure power supplied to the ESR source device with the light source turned off and the light source turned on, such as a precision voltage meter and precision current meter, where Voltage*Current=Power; and (13) separate means (e.g., a spectrometer) to measure the relative spectral distribution of light output from the ESR source device.

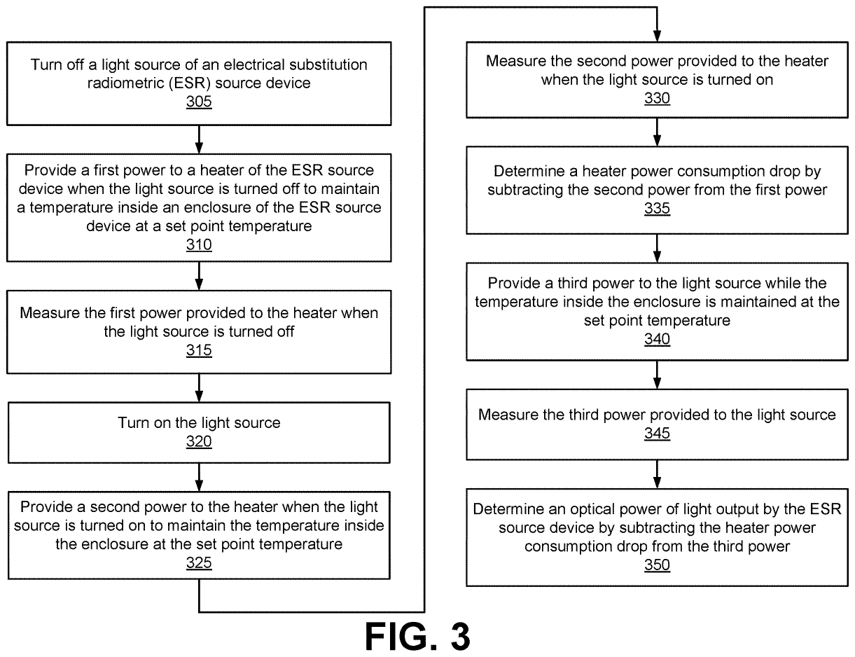

FIG. 3 is a flowchart for a method of operating an ESR source device for determining an optical power of light output by the ESR source device, in accordance with one or more embodiments. Alternative embodiments may include more, fewer, or different steps from those illustrated in FIG. 3, and the steps may be performed in a different order from that illustrated in FIG. 3. These steps may be performed by components of the ESR source device, e.g., by components of the ESR source device 100 in FIG. 1, and/or components of the ESR source device 201 in FIG. 2. Alternatively, or additionally, some of the steps may be performed by one or more devices not being part of the ESR source device. Additionally, each of these steps may be performed automatically by the components of the ESR source device or components of the assembly associated with the ESR source device without human intervention.

At 305, a light source (e.g., LED, laser diode, or some other light source) of the ESR source device is turned off. At 310, a first power is provided to a heater of the ESR source device when the light source is turned off to maintain a temperature inside an enclosure of the ESR source device at a set point temperature. At 315, the first power provided to the heater when the light source is turned off is measured.

At 320, the light source is turned on. At 325, a second power is provided to the heater when the light source is turned on to maintain the temperature inside the enclosure at the set point temperature. At 330, the second power that is provided to the heater when the light source is turned on is measured. At 335, a heater power consumption drop is determined by subtracting the second power from the first power.

At 340, a third power is provided to the light source while the temperature inside the enclosure is maintained at the set point temperature. At 345, the third power that is provided to the light source is measured. At 350, an optical power of light output by the ESR source device is determined by subtracting the heater power consumption drop from the third power.

### ADDITIONAL CONSIDERATIONS

The ESR source device disclosed herein provides several advantages over conventional electrical substitution radiometers (ESRs) and other approaches for calibrating optical sources. By integrating the light source, heater, temperature sensor, and thermal enclosure into a single self-contained assembly, the ESR source device enables accurate, in-situ determination of optical output power without requiring an external, highly absorptive cavity or coating of the type relied upon in conventional electrical substitution radiometry. This integration may reduce implementation cost and complexity, and may permit the device to be deployed as a portable, calibrated optical source that can be co-located with the system or instrument under test, rather than requiring transport of the source to a dedicated calibration laboratory.

Additional advantages may include improved measurement accuracy and spectral versatility. Because the optical output power is determined using precisely measured electrical quantities supplied to the light source and to the heater while the enclosure is held at a constant temperature set point, the ESR source device may avoid many of the uncertainties associated with absolute optical detectors and absorber-based measurements. Operating the light source through on/off (or dithered) cycles while the temperature controller maintains the temperature set point may provide a continuous electrical-substitution baseline, thereby compensating for drift and ambient variations and enabling repeatable measurements over time. Maintaining the light source at a controlled temperature set point may further stabilize the emitted spectrum, allowing a single device to function as a calibrated spectral radiance source across a range of light source types (e.g., LEDs, laser diodes, halogen lamps, etc.) and across ultraviolet, visible, and infrared wavelengths. The disclosed device may also be used to characterize the quantum efficiency of light detectors, providing a versatile calibration tool suitable for a broad range of radiometric and photometric applications.

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. An electrical substitution radiometric (ESR) source device, comprising:
a light source configured to emit light;
an enclosure configured to absorb as heat a first portion of the light emitted by the light source that was not output outside of the enclosure;
a heater in thermal contact with the light source;
a temperature sensor in thermal contact with the light source and the enclosure;
a heater power supply configured to provide to the heater a first electrical power when the light source is turned off and a second electrical power when the light source is turned on;
a light source power supply configured to provide an electrical power to the light source; and
a controller coupled to the temperature sensor, the heater power supply, and the light source power supply, the controller configured to maintain a temperature inside the enclosure at a set point temperature when the light source is turned off and when the light source is turned on.

2. The ESR source device of claim 1, further comprising:
an aperture for controlling spatial distribution of light output outside of the enclosure representing a second portion of the light emitted by the light source.

3. The ESR source device of claim 1, further comprising:
a fiber optic for controlling spatial distribution of light output outside of the enclosure representing a second portion of the light emitted by the light source.

4. The ESR source device of claim 1, wherein the controller is further configured to:
control the heater power supply to provide the first electrical power to the heater when the light source is turned off to maintain the temperature inside the enclosure at the set point temperature;
control the heater power supply to provide the second electrical power to the heater when the light source is turned on to maintain the temperature inside the enclosure at the set point temperature, wherein the second electrical power is less than the first electrical power; and
control the light source power supply to provide the electrical power to the light source while the temperature inside the enclosure is maintained at the set point temperature.

5. The ESR source device of claim 4, wherein the controller is further configured to:
receive a temperature signal from the temperature sensor that is indicative of the temperature inside the enclosure; and
control, using the received temperature signal, operation of the heater power supply for providing power to the heater to maintain the temperature inside the enclosure at the set point temperature.

6. The ESR source device of claim 1, further comprising:
a first apparatus configured to measure the first electrical power when the light source is turned off and the second electrical power when the light source is turned on; and
a second apparatus configured to measure the electrical power provided to the light source when the light source is turned on.

7. The ESR source device of claim 6, wherein the first apparatus comprises:
a voltage meter configured to measure a first voltage applied to the heater when the light source is turned off and a second voltage applied to the heater when the light source is turned on; and
a current meter configured to measure a first current provided to the heater when the light source is turned off and a second current provided to the heater when the light source is turned on.

8. The ESR source device of claim 6, wherein the second apparatus comprises:
a voltage meter configured to measure a voltage applied to the light source; and
a current meter configured to measure a current provided to the light source.

9. The ESR source device of claim 1, further comprising:
an insulation layer placed at an outer surface of the enclosure.

10. The ESR source device of claim 1, wherein the light source is mounted inside the enclosure.

11. The ESR source device of claim 1, further comprising:
an apparatus configured to measure a spectrum of a second portion of the light emitted by the light source and output outside of the enclosure.

12. The ESR source device of claim 1, wherein the light source is a light emitting diode (LED), a laser diode, or a halogen lamp source.

13. The ESR source device of claim 1, further comprising:
a coating placed on an inner surface of the enclosure having an emissivity greater than a threshold value.

14. A method performed at an electrical substitution radiometric (ESR) source device, the method comprising:
turning off a light source of the ESR source device;
providing a first electrical power to a heater of the ESR source device when the light source is turned off to maintain a temperature inside an enclosure of the ESR source device at a set point temperature;
measuring the first electrical power provided to the heater when the light source is turned off;
turning on the light source;
providing a second electrical power to the heater when the light source is turned on to maintain the temperature inside the enclosure at the set point temperature;
measuring the second electrical power provided to the heater when the light source is turned on;
determining a power consumption drop of the heater by subtracting the second electrical power from the first electrical power;
providing a third electrical power to the light source while the temperature inside the enclosure is maintained at the set point temperature;
measuring the third electrical power provided to the light source; and
determining an optical power of light output by the ESR source device by subtracting the power consumption drop from the third electrical power.

15. The method of claim 14, wherein providing the first electrical power to the heater comprises:
controlling a heater power supply to provide the first electrical power to the heater when the light source is turned off to maintain the temperature inside the enclosure at the set point temperature.

16. The method of claim 15, wherein providing the second electrical power to the heater comprises:
controlling the heater power supply to provide the second electrical power to the heater when the light source is turned on to maintain the temperature inside the enclosure at the set point temperature, wherein the second electrical power is less than the first electrical power.

17. The method of claim 14, wherein providing the third electrical power to the light source comprises:
controlling a light source power supply to provide the third electrical power to the light source while the temperature inside the enclosure is maintained at the set point temperature.

18. The method of claim 14, further comprising:
receiving, at a controller, a temperature signal from a temperature sensor in thermal contact with the light source and the enclosure, the temperature signal indicative of the temperature inside the enclosure; and
controlling, using the received temperature signal, operation of a heater power supply for providing power to the heater to maintain the temperature inside the enclosure at the set point temperature.

19. The method of claim 14, wherein:
measuring the first electrical power provided to the heater comprises:
measuring, by a precision current meter coupled to a heater power supply, a first current provided to the heater by the heater power supply when the light source is turned off, and
measuring, by a precision voltage meter coupled to the heater power supply, a first voltage applied to the heater by the heater power supply when the light source is turned off; and
measuring the first electrical power provided to the heater comprises:
measuring, by the precision current meter, a second current provided to the heater by the heater power supply when the light source is turned on, and
measuring, by the precision voltage meter, a second voltage applied to the heater by the heater power supply when the light source is turned on.

20. The method of claim 14, wherein measuring the third electrical power provided to the light source comprises:
measuring, by a precision current meter coupled to a light source power supply, current provided to the light source by the light source power supply when the light source is turned on; and
measuring, by a precision voltage meter coupled to the light source power supply, a voltage applied to the light source by the light source power supply when the light source is turned on.
